(19) United States
(12) Patent Application Publication
(10) Pub. No.: US 2014/0207550 A1
(43) Pub. Date: Jul. 24, 2014

(54) METHODS AND SYSTEMS OF PROVIDING TRANSACTION TERMS OFFERS IN REAL TIME

(71) Applicant: ARTOPAY LTD., Natania (IL)

(72) Inventors: Michael Eden, Natania (IL); Tomer Eden, Natania (IL)

(73) Assignee: ARTOPAY LTD., Natania (IL)

(21) Appl. No.: 14/224,988

(22) Filed: Mar. 25, 2014

Related U.S. Application Data
(63) Continuation of application No. PCT/IB2012/055312, filed on Oct. 3, 2012.
(60) Provisional application No. 61/542,315, filed on Oct. 3, 2011.

(51) Int. Cl. G06Q 30/02; G06Q 20/22

(52) U.S. Cl. CPC G06Q 30/0222; G06Q 20/22
USPC 705/14.23

(57) ABSTRACT

A method of providing a consumer with different transaction terms offers for performing a potential financial transaction. The method comprises identifying a potential financial transaction between a retailer and a consumer, identifying a plurality of payment methods which are available to the consumer for performing the potential financial transaction, acquiring a plurality of transaction terms offers for performing the potential financial transaction each using another of the plurality of payment methods, and outputting respective the plurality of transaction terms offers for presentation to the consumer.

### CROSS REFERENCE TO RELATED APPLICATIONS

This application is a continuation of international application PCT/IB2012/055312 filed Oct. 3, 2012, which claims the benefit of U.S. provisional patent application No. 61/542,315 filed Oct. 3, 2011, the contents of which are incorporated by reference.

### FIELD AND BACKGROUND

The present invention, in some embodiments thereof, relates to financial transactions and, more particularly, but not exclusively, to methods and systems of providing transaction terms offers.

The use of credit cards for purchasing goods and services has exploded, with a staggering number of credit card transactions performed each day. Credit cards offer convenience to buyers and sellers by facilitating transactions for the purchases of goods and services. With an increase in online shopping, credit cards and online credit services, such as PayPal™, are more frequently being used. In the current credit environment, a person also typically can chose among several credit cards from one or more institutions and other payment methods for performing financial transactions. Given the rapid growth of commerce over the Internet, where credit cards and online payment services are the preferred methods of payment, the number of payment methods which are available for each user and the number of transactions each user performs are likely to increase.

### SUMMARY

According to some embodiments disclosed herein, there is provided a method of providing a consumer, for example a subscriber, with different transaction terms offers for performing a potential financial transaction. The method comprises identifying a potential financial transaction between a retailer and a consumer, identifying a plurality of payment methods which are available to the consumer for performing the potential financial transaction, acquiring a plurality of transaction terms offers for performing the potential financial transaction each using another of the plurality of payment methods, and outputting respective the plurality of transaction terms offers for presentation to the consumer.

Optionally, the identifying comprises identifying the location of the consumer and matching the location with a plurality of records each indicative of one of a plurality of potential financial transactions in one of a plurality of locations.

Optionally, the identifying comprises identifying a web address and matching the web address with a plurality of records each indicative of one of a plurality of potential financial transactions in one of a plurality of web addresses.

Optionally, each the payment method is acquired from a terminal of a financing provider that provides a service selected from a group comprising: a credit card type, a consumers club, a coupon service, a Web-based financing service, and a cash payment. Optionally, the acquiring comprises identifying at least one characteristic of the consumer by analyzing at least one of a history of financial transactions, at least one demographic characteristic, and available payment methods, and forwarding the at least one characteristic to plurality of terminals which provide the plurality of transaction term offers accordingly.

Optionally, the acquiring comprises identifying an additional payment method which is currently not available to the consumer, sending information pertaining to the consumer to a provider module associated with the additional payment method, and acquiring at least one additional transaction term offer in response to the information; wherein the outputting comprises outputting the at least one additional transaction term offer.

More optionally, the at least one additional transaction term offer includes a temporary credit card number for performing the potential financial transaction.

Optionally, the acquiring comprises adjusting at least some of the plurality of transaction terms offers according to a change in a member of a group consisting of an interest rate, a demand for the potential financial transaction, a profile of the consumer, and history of previously conducted financial transactions.

Optionally, the acquiring comprises extracting a consumer profile record of the consumer and personalizing at least some of the plurality of transaction terms offers according to the consumer profile record.

Optionally, the outputting comprises calculating a predicted transaction cost of each the transaction terms offer and ranking each the transaction terms offer according to the predicted transaction cost.

Optionally, each the transaction terms offer defines at least one member of a group consisting of a number of optional installments, a regular payment cost, rewards redemption, and at least one benefit to the consumer.

Optionally, the acquiring comprises: dividing the potential financial transaction to a plurality of transactions, defining a plurality of combinations each of a group of the plurality of payment methods, and acquiring a plurality of additional transaction term offers for performing the potential financial transaction each using another of the plurality of combinations. The outputting comprises outputting the plurality of additional transaction term offers for presentation to the consumer.

Optionally, the acquiring comprises ranking each one of the plurality of transaction term offers; wherein the outputting comprises acquiring one of the plurality of transaction term offers for automatically performing the potential financial transaction according to the ranking.

Optionally, the ranking is performed according to a credit line of the consumer in each the payment method.

According to some embodiments disclosed herein, there is provided a system of providing a consumer with different transaction terms offers for performing a potential financial transaction. The system comprises an interface which receives from a consumer terminal via a network an indication of a potential financial transaction between a retailer and a first of a plurality of consumers and a matching module which selects one of a plurality of consumer records according to the indication and acquires a plurality of transaction terms offers for performing the potential financial transaction using any of a plurality of payment methods which are available to the first consumer a via the network. The interface forwards the plurality of transaction terms offers to the consumer terminal so as to allow the presentation thereof to the first consumer.

Optionally, the system further comprises a billing module which monitors an outcome of presenting the plurality of transaction terms offers to the consumer and updates a billing record of one of the operators of the plurality of financing provider terminals accordingly.

Optionally, the system further comprises a database which stores a plurality of consumer records each documenting a plurality of payment methods which are available for another of a plurality of consumers, wherein the matching module acquires respective the plurality of payment methods which are available to the first consumer from the database.

According to some embodiments disclosed herein, there is provided a method of searching a financial transaction for purchasing at least one of a product and a service. The method comprises receiving from a consumer terminal of a consumer a search query defining at least one of a product and a service, identifying a plurality of potential financial transactions to purchase the at least one of the product and the service, identifying a plurality of payment methods which are available to the consumer for performing each the potential financial transaction, acquiring a plurality of transaction terms offers for performing each the potential financial transaction each using another of respective the plurality of payment methods, generating a response to the search query which comprises at least some of the plurality of potential financial transactions each associated with at least some of respective the plurality of transaction terms offers, and responding to the search query with the response.

Optionally, the search query is indicative of a location of the consumer, the identifying the plurality of potential financial transactions is performed according to the location.

Optionally, the search query defines at least one preference of the consumer, the acquiring is performed according to the at least one preference.

According to some embodiments, there is provided a system of providing each of a plurality of consumers with different transaction terms offers for performing a potential financial transaction. The system comprises a plurality of consumer modules each installed in a consumer terminal and configured for sending, via a network, an indication of a potential financial transaction between a retailer and a respective of a plurality of consumers; and a plurality of financing provider modules, each the financing provider module is adapted to receive a message indicative of the potential financial transaction, via the network, and responding thereto with a respective transaction terms offer. The respective the consumer module which receives a plurality of transaction terms offers each from another of the plurality of financing provider modules and presents the plurality of transaction term offers to the respective consumer.

Optionally, a central unit which receives the indication and distributes a plurality of messages each indicative of the potential financial transaction to the plurality of financing provider modules accordingly.

Optionally, a plurality of retailer modules, each adapted to receive the message and to communicate respective retailer terms to any of the plurality of financing provider modules according to an analysis of the potential financial transaction

More optionally, each the financing provider module calculates the respective transaction terms offer according a profitability analysis.

Optionally, each the financing provider module calculates the respective transaction terms offer based on at least one response of the respective consumer module to previous transaction terms offers pertaining to the potential financial transaction.

Optionally, each the financing provider module calculates the respective transaction terms offer based on preferences of the respective consumer.

More optionally, the profitability analysis is based on at least one characteristic of the respective consumer.

Optionally, the profitability analysis is based on statistical analysis of success and failure of previously distributed transaction terms offers.

Optionally, the profitability analysis is based on analysis of financial transactions previously conducted by the respective consumer.

Optionally, the profitability analysis is based at least one of a respective account status and revenue to a respective financing provider.

Unless otherwise defined, all technical and/or scientific terms used herein have the same meaning as commonly understood by one of ordinary skill in the art to which the invention pertains. Although methods and materials similar or equivalent to those described herein can be used in the practice or testing of the disclosed embodiments, exemplary methods and/or materials are described below. In case of conflict, the patent specification, including definitions, will control. In addition, the materials, methods, and examples are illustrative only and are not intended to be necessarily limiting.

Implementation of the method and/or system of the disclosed embodiments can involve performing or completing selected tasks manually, automatically, or a combination thereof. Moreover, according to actual instrumentation and equipment of embodiments of the method and/or system, several selected tasks could be implemented by hardware, by software or by firmware or by a combination thereof using an operating system.

For example, hardware for performing selected tasks according to the disclosed embodiments can be implemented as a chip or a circuit. As software, selected tasks according to the embodiments can be implemented as a plurality of software instructions being executed by a computer using any suitable operating system. In an exemplary embodiment, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments are described herein, by way of example only, with reference to the accompanying drawings. With specific reference now to the drawings in detail, it is stressed that the particulars shown are by way of example and for purposes of illustrative discussion of the disclosed embodiments. In this regard, the description taken with the drawings makes apparent to those skilled in the art how the various disclosed embodiments may be practiced.

In the drawings:

FIG. 1 is a schematic illustration of a system for providing a consumer with different transaction terms offers pertaining to different payment methods for a potential financial transaction, according to one embodiment;

FIG. 2 is a flowchart of a method for providing a consumer with different transaction terms offers, according to one embodiment; and

FIG. 3 is a flowchart of a method of searching transaction terms offers for one or more potential financial transactions which meets the terms of a search query, according to one embodiment.

### DETAILED DESCRIPTION

The various embodiments disclosed herein relate to financial transactions and, more particularly, but not exclusively, to methods and systems of providing transaction terms offers.

According to some embodiments there are methods and systems of providing a consumer with transaction terms offers for performing a potential financial transaction. The transaction terms offers are received through payment methods, optionally including payment identified with membership cards, which are available or made available (e.g. virtual payment identifiers and/or virtual clubs) to the consumer dynamically. The transaction terms offers are optionally acquired from terminals of financing providers, such as credit card service providers, online credit providers, and/or other mediums which facilitate exchanging goods and/or services for a debit. The transaction terms offers are optionally acquired in real time, just before a potential financial transaction, such as a purchase of product(s) and/or service(s) is about to occur. For example, the transaction terms offers are provided after the purchase process has begun, for example after the consumer selects a product in a store, initiates a payment session with a cashier, selected an outfit in a dress store and/or the like. The transaction terms offers are optionally updated and/or generate according to the consumer identity, consumer preferences, variables such as interest rate, supply and demand, transaction history of the consumer, demographic data, and/or purchase pattern analysis. The transaction terms offers are optionally ranked and/or filtered according to the preferences of the consumer, transaction history of the consumer, demographic data, and/or purchase pattern analysis. The system may enable the consumer to choose the financial terms and method manually, choosing which terms are more important for a potential transaction and/or automatically, for example based on consumer bank status, expected transactions, profile, preferences and/or elements of the potential transaction (i.e. amount, item bought and the like.).

Automatic preferences—the system analyzes the consumer's status to find the optimal preferences to be sent to the financing providers (e.g. the system will identify that the consumer will reach his credit line limit within few weeks on a given payment card, and will send a request to the financing provider for offers where the credit line is extended)
Optionally, the system enables financing providers to offer benefits according to the consumer profile and/or preferences and to collaborate online with retailers on the offered terms.

In some embodiments, transaction terms offers are provided based on a potential financial transaction between a retailer and a consumer. The potential financial transaction may be identified by a consumer input and/or automatically, for example based on a combination of the consumer location and a barcode, an indication from a cash register, a visited web page and/or, a selected web address the like. This allows identifying a plurality of payment methods which are available to the consumer for performing the potential financial transaction. The payment methods may include payment methods she uses and new payment methods, including payment identified with benefits providers (e.g. membership cards) which may be suggested thereto. Now, a plurality of transaction terms offers for performing the potential financial transactions are acquired. This allows forwarding the transaction terms offers for presentation to the consumer, for example on one or more of her handheld devices.

In some embodiments, a system that includes a central unit is connected via the network to consumer and financing provider modules and terminals is provided. The central unit may also be connected to retailer modules and terminals, facilitating the updating of a database of potential financing transactions and optionally commercial terms, discounts and/or the like, according to communication with the retailer modules and terminals.

The central unit includes an interface which receives from a consumer terminal, via a network, an indication of a potential financial transaction between a retailer and a consumer. The central unit further includes and a matching module which acquires a plurality of transaction terms offers for performing the potential financial transaction using any of a plurality of payment methods which are available to the consumer from the financing modules via the network. Optionally, the identification of transaction terms and/or payment methods may not be in real-time, where data is collected in from customer's account terms. The interface forwards the acquired transaction terms offers to the consumer terminal so as to allow the presentation thereof to the consumer and/or automatic selection as described below.

Optionally, the central unit allows retailers to negotiate the transaction terms offers with financing providers and/or to upload transaction terms offers of their own. In such a manner, a retailer may promote his clients to use a preferred payment method.

According to some embodiments, there are methods and systems which allow a consumer to search for financial transaction(s) for purchasing product(s) and/or service(s) optionally based on transaction term preferences and/or respective transaction terms offers rankings. The method is based on receiving from a consumer terminal of a consumer a search query defining product(s) and service(s). Then respective potential financial transactions are identified (i.e. product and/or service), for example by reviewing a plurality of financial transactions which are uploaded by retailers and collected by the central unit. Then, payment methods which are available, optionally including virtual methods that become available specifically for this specific transaction, to the consumer for performing each one of the potential financial transactions are identified. The retailer may upload products/services and their prices for drawing customers. This allows, for example as outlined above and described below, acquiring a plurality of transaction terms offers for performing each one of the potential financial transactions. Each potential financial transaction may be performed using another of payment method. Now, a response to the search query which includes at least some of potential financial transactions each associated with at least some of the respective transaction terms offers is generated and forwarded to the consumer.

As further described below, a number of different transaction terms offered by retailers along with the transaction terms offered by the financing methods for each financing transaction (i.e. discount offered by retailer A along with terms offered by card X sum to $x while retailer B and card Y sum to $y).

Before explaining at least one embodiment in detail, it is to be understood that the embodiment is not necessarily limited in its application to the details of construction and the arrangement of the components and/or methods set forth in the following description and/or illustrated in the drawings and/or the Examples. The invention is capable of other embodiments or of being practiced or carried out in various ways.

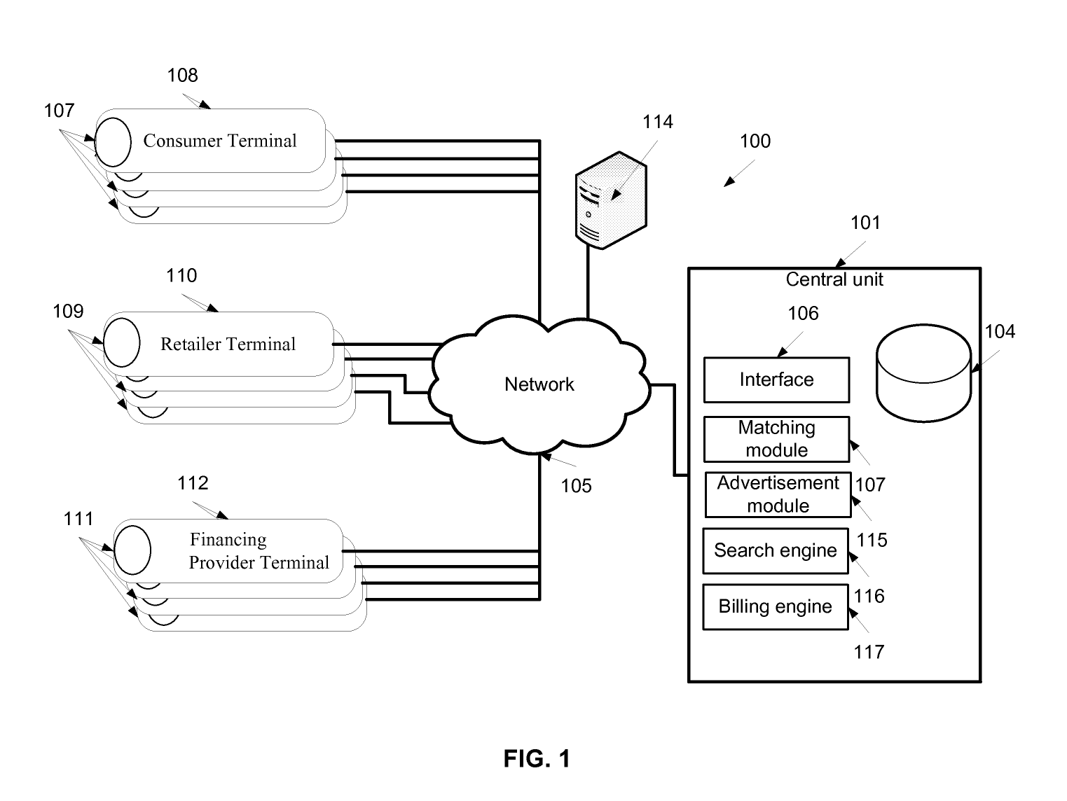

Reference is now made to FIG. 1, which is a schematic illustration of a system 100 for providing a consumer with different transaction terms offers pertaining to different payment methods for a potential financial transaction, according to some embodiments.

Optionally, the system 100 includes a central unit 101 that functions as a hub connecting terminals of consumers, retailers, and/or financing providers and optionally implemented on one or more servers connected to a network 105 and/or as a module which is installed in a client terminal for offline usage and/or distributed over a plurality of client terminals and accessed using peer to peer paradigm. The central unit 101 optionally communicates with a plurality of modules which are installed on different terminals. As used herein, a consumer may be a user which has been previously registered to the system (i.e. subscriber) and/or a first time user which is automatically registered in the system and/or any other user which is identified for one or more system accesses. Each one of these modules, for example modules 107, 109, and/or 111 described below, may be installed on a customer premises equipment (CPE), for example a laptop, a desktop, a server, a Smartphone, a tablet, a cash register, and/or any network node that communicates with the central unit 101 via a network 105, such as the Internet or an Ethernet or a phone line.

Optionally, the system 100 includes consumer modules 107 which may be implemented as software components executed by hosting terminals 108. For example, the consumer module 107 is an application from an app store, an add-on, a standalone application and/or application that is set to be installed on a handheld device, such as a Smartphone, a tablet, and/or the like. The consumer module 107 may also be a widget and/or any other interactive element that is presented to the user via a browser.

Such a system 100 allows consumers to use their terminals 107, for example handheld cellular devices, to receive information about a plurality of offers which suggest optional transaction terms under which a potential financial transaction may be made. The information allows the user and/or an automatic selection module to select a preferred payment method. For example, an offer for transaction terms may define a number of payments, debiting date(s), acquired credit(s), total price, a discount, a benefit, a penalty, and/or the like.

A potential financial transaction may be a potential payment for one or more products, a potential payment for one or more services, an entrance to a location, a passage via a location or a product, for example either in the premises of an actual store or in an online store, a potential financial commitment, for example a loan, a commitment to purchase a product or a service, and/or the like. Optionally, as further described below, a potential financial transaction may be identified according to an analysis of the location of a user, for example coordinates acquired using a navigation module, such as a global positioning system (GPS) module, an assisted GPS (A-GPS) module and/or the like.

Optionally, a potential transaction is identified according to location and enables card companies and retailers to offer benefits to the user, benefits optimization according to users' presence in a given location.

Optionally, as further described below, a potential financial transaction may be identified according to user purchasing patterns, for example as extracted from an automatic analysis of documented purchases, for example credit card bill(s), coupon purchases, money withdrawal and/or the like.

Optionally, the system 100 includes one or more retailer modules 109. The retailer module 109 may be implemented as software components executed by hosting terminals 109, such as a retailer server. As further described below, the retailer module 109 may provide a way to draw consumers according to a predefine or dynamic policy and/or to optimize a benefits level. The retailer module 109 may be implemented as a software component managed by the central unit 101, for example a webpage or another user interface that allows a retailer to input data. The retailer modules allow retailers to update and/or provide retailer term(s) and/or details of potential financial transactions. It should be noted that the retailer modules may allow retailers to update retailer terms, for example as described below to a group of consumers matching a certain consumer type and/or personalized per consumer so that each consumer receive retailer terms which are separately calculated for him.

For example, the central unit 101 optionally manages a plurality of financial transaction records each includes offer(s) of one or more retailer(s). Each offer is associated with retailer terms, for example price, benefits to the purchaser and/or the like and/or details, for example sale venue(s), for example in coordinates, and/or the like. The retailer terms and details are optionally updated by the retailer, for example either manually using a user interface or automatically, for example by a designated module. Optionally, the profile of the offer applies to a limited time frame.

Optionally, the retailer module 109 automatically sets retailer terms, for example iteratively or continuously, according to an analysis of user profile(s) for example based on user purchase history, effect of previous promotions on the specific user purchases, an estimated user risk level, an expected commission to a card company and/or a processor, and/or current status(es) and/or current location(s), for example number of potential users in a geographical place. The analysis may be of consumers which receive offer(s) with certain retailer terms and/or did not receive such offer(s).

Additionally or alternatively, the retailer module 109 automatically sets retailer terms according to retailer terms of one or more other retailers, for example offered benefits. Additionally or alternatively, the retailer module 109 automatically sets retailer terms according to product availability, for example inventory status, current occupancy at the retailer store and/or the like. Optionally, the retailer terms are updated with discounts and/or benefits (increases or decreases) in real-time. The retailer module 109 allows a respective retailer to increase revenue and/or acceptance rate by optimizing retailer terms. Optionally, the retailer module 109 tracks history of consumers and calculates accordingly the effects of different retailer terms, for example discounts and/or coupons, on different consumer types, for example with different demographic characteristics. This allows calculating the return of investment of different retailer terms and identifying accordingly preferred terms, optionally estimated as optimal, per consumer that matches the respective consumer type.

For example, the retailer module 109 performs the following process. Data about purchases of the consumers such as business locations, the time of purchase, the scope of purchase, the purchased products or services and optionally the paid price is gathered. Data from external services may also be gathered, for example from shop lists and/or data from the cellular payment systems (e.g. Mobile wallet).

Data about the retailer terms which are provided by different businesses are also gathered, for example divided according to the locations of the businesses and/or types and/or validity of the terms. The retailer module 109 identifies which retailer terms have been suggested to which consumers, for example as responses to searches. Any other presentation of terms may be monitored, for example site visiting and/or the like. The retailer module 109 identifies the effect(s) (purchase or did not purchase) of the suggested retailer terms on the consumers. The effect(s) may be measured during the given retailer terms and/or after the given retailer terms. The effect(s) may be measured for current and/or previous consumers.

Now, the retailer module 109 calculates the return of investment of the retailer terms, for example by taking into account the cost of the retailer terms and actual return. Optionally, the effect of retailer terms on surrounding and/or related businesses is also taken into account, for example whether it increases and/or decreases respective purchases in surrounding and/or related businesses.

Optionally, the retailer module 109 includes a user interface that allows querying the effect of different retailer terms, for example by matching between exemplary retailer terms and the historical data. In such a manner, the retailer can set retailer terms which match a consumer type of certain consumers. For example, consumers, which are in a certain age group, of a certain gender, of a certain socioeconomic group, are presented with retailer terms that have the best effect on the respective consumers which are logged in the history file. Optionally, the retailer module 109 outputs alerts and/or notifications about retailer terms which are suggested by competitors and/or about attractive retailer terms which are detected, for example for a selected consumer type, in real time.

Optionally, the retailer module 109 allows providing different retail terms according to location of consumers, for example in a manner that attracts consumers which are located near a point of service and/or a selling store. Optionally, the retailer module 109 weights retailer terms according to the statistical probability it have a positive and/or negative effect(s) on the purchasing of the respective product. The statistical probability may be derived from the logged data.

The retailer module 109 optionally automatically updates the cost of services and/or products in real time, providing an accurate figure about the actual cost of different retailer terms.

The retailer module 109 allows retailers to control their budget and/or policy in real time, taking into account actual price, availability, and number of consumers. The retailer can now address selected consumers with retailer terms which are more attractive for them. As described above, data is updated in real time, facilitating a retailer with the ability to adapt the current retailer terms to product cost and market changes and/or to reselect groups of offerees. For example, as the stock availability decreases, the offer is presented to fewer consumers and/or address consumer gradually where offers are proposed to different groups, optionally with a decreasing return of investment estimations. In another example, the demand in a certain group increases; prices which are suggested to members of that group are adapted.

The retailer module 109 allows updating a website according to performances in stores and/or vice versa.

Optionally, the retailer modules 109 allow retailers to upload new potential financial transactions to the systems. These potential financial transactions are optionally recorded by the central unit 101. The recorded potential financial transactions may be accessed by the financing provider module(s) 111 for analysis and for determining transaction terms offers.

The system 100 optionally includes financing provider modules 111 that allow financing providers, such as credit card service providers, to compete over a potential financial transaction by dynamically offering various transaction terms offers which are adapted to the consumer. A provider module 111 may be implemented as software component executed by a hosting terminal 112, such as a financing provider server, for example a credit card company server. The provider module 111 may be implemented as software component managed by the central unit 101 and optionally allows an operator to input financing provider data, for example via a webpage and/or a user interface. The financing provider module(s) allow financing providers to update and/or provide financing provider terms pertaining to different potential financial transactions, optionally based on the history of the respective consumer. For example, the matching module 107 sends financing provider servers 112 a notification indicative of a potential financial transaction which may be executed by a consumer that uses their services. This allows the financing provider and/or retailers to respond, in real-time, with financing provider terms for the different potential financial transaction, for example based on the profile or the specific identity of the respective consumer and/or retailer. In another example, the financing provider modules 111 allow financing providers to update transaction terms offers, for example in respective to selected financial transaction records. The transaction terms offers may include financing provider terms such as a benefit to the consumer, a number of payments (installments), interest rate, deferred payment period, an interest for a respective debit, a proposition for an additional purchase in a discounted price, amended account terms (e.g. reducing general account annual percentage rate (APR), increasing the account credit ceiling), and/or the like. For example, the financing provider module 107 is an application from an add-on, a standalone application and/or a hardware component that is installed in the hosting terminal 112, for example an integrated circuit (IC). The financing provider module 107 optionally conducts a negotiation process with the central unit 101. During the negotiation process, transaction term offers may be accepted, declined, adjusted and/or the like in any of number of rounds. As further described below, the central unit asks for transaction terms for each financial method from a number of different financing provider modules 107 and may be able to send rejections when the received transaction term offers are not suitable to the consumer's preferences (for instance when other provider offers preferred terms). A rejection response could include one or more limitations or preferences for minimal transaction term offers.

The financing provider module 107 optionally allows financing providers to generate offers with ‘ad-hoc’ transactions terms based on identified potential financial transactions of registered and non-registered consumers and/or issuing ‘ad-hoc’ virtual payments.

Optionally, the financing provider module 107 optionally allows financing providers to optimize the offers in real-time, for example according to market terms and/or respective customer information. The identified potential financial transactions are actually a new layer of information that allows reaching consumers in real-time with highly targeted terms.

Optionally, the financing provider module 107 analyzes the identified potential financial transactions and a respective consumer record and dynamically offers highly targeted transaction terms in real-time to draw consumers to use the financing services of the respective financing provider. The financing provider module 107 may calculate most cost effective terms for a specific transaction, for a group of transactions or to a certain consumer having certain characteristics.

The financing provider module 107 communicates with the central unit 101, receives an identified potential financial transaction therefrom and generates one or more offers accordingly. The offer may be calculated based on expected revenues from this potential financial transaction, expected revenues from the consumer on the long run, and a cost of offering these terms. The financing provider module 107 enables the financing provider to find multiple terms options to a single transaction request that the consumer will be able to choose from. Every terms option is ranked by the total value it brings to the financing provider.

The financing provider module 107 optionally finds optimal terms according to historical analysis. The financing provider module 107 learns and adjusts the offered terms by analyzing the offers acceptance ratios and finding the most attractive terms to be offers for a group of consumers and for individual customer. After analyzing the acceptance rate, the financing provider module 107, as described above, calculates the value versus cost of each possible transaction terms offers. The system takes into account one or more of the following:

conversion rate—the number terms identified potential financial transactions that were leading eventually to an actual transaction divided by the number of total requests for offers;

market share—the number of transactions carried by the financial provider and divided by the number of transactions carried by other financial providers;

requests volume—total requests sent to the system; and

transactions volume—total number of transactions that were carried by the consumers.

Optionally, total number of transactions is broken into clusters and these parameters are measured for each cluster separately. The clusters are defined by the following: type of merchants, type of consumers, type of transactions (i.e. purchase amount, time and date, and location) and the type of terms offered (i.e. low interest installments, discount, and cash back).

For example, the following are calculated: the conversion rate for transactions in grocery shops on the last 2 days, the rate that was on the last month, and the market share of the respective financing provider among consumers on the age of 25-30 with gold cards that were offered cash back when shopping in malls. By analyzing these parameters and their changing patterns, the financing provider is able to assess the attractiveness of the offered transaction terms and make decision whether they need to be adjusted or even changed. For example, when a reduction in conversion rate on a given cluster is identified, the system advises to increase a discount level for transactions of this type or using different type of preferred terms. Then, the system conducts continues trial-and-error tests for selected consumers on selected cluster for finding the optimal terms. For example, 12 customers are picked from a given cluster and offered with a coupon for a restaurant visit if they will use the card for a volume purchase of over $500. A higher conversion rate indicates that this offering is better than existing one (although the cost of this benefit may be evaluated too).

Optionally, the financing provider module 107 optimizes the bid process. On this process, the system analyzes the terms that were offered for previous requests and their success rates for finding the optimal way of ‘wining’ a bid. On this process the financing provider module 107 learns what are the most effective terms by breaking them to clusters of consumers' profiles, merchants and transactions information (i.e. date and time, amount, and/or required installations. This process helps financing provider module 107 to adapt and compete with other financing provider modules 107. For example, bids success rates on transactions that were carried in gas stations with gold cards weren't changed even though the offered cash back reduced from 8% to 6% (therefore 6% could be sufficient). In another example, the financing provider module 107 allows virtual card companies to increase discount beyond a maximum group discount if the return is calculated as worth it.

Optionally, the financing provider module 107 identifies severe behavior patterns based on consumers' behavior patterns that leads to card cancellation (or the cards weren't extended after expiration date) or significant reduction in card usage and/or significant reduction in terms requests. The system takes into account the following parameters for identifying behavior patterns:

volume and frequency of card usage;

conversion rate—percentage of requests that were leading to actual transaction; and

customer profile.

As these patterns identified to be leading to severe events, the financing provider enters to a ‘retention mode’ where highly attractive terms are offered to the customer on a sequence of transactions. Attractive terms can be defined manually by the financing provider or can identified by the financing provider module 107 automatically as terms that were proved as effective to keep consumers from leaving or reducing their use of the card.

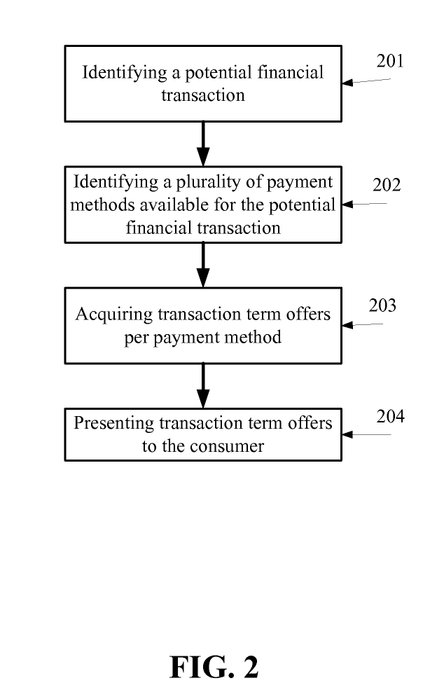

Reference is now also made to FIG. 2, which is a flowchart of a method 200 for identifying different transaction terms offers for a certain potential financial transaction, according to some embodiments. The method 200 is optionally performed by a matching module 107 that is installed on the central unit 101. The matching module 107 optionally ranks the different transaction terms offers and/or automatically selects a suitable offer for performing the certain potential financial transaction based on data that is acquired from a database 104 and/or the modules 107, 109, and/or the 111, for example as further described below.

First, as shown at 201, a potential financial transaction between a retailer and a consumer is identified. The potential financial transaction may be identified automatically using a consumer module, such as 107, which is installed on the consumer terminal 108 of the consumer. For example, a user interface (UI) allows the user to input data pertaining to the potential financial transaction and/or to select the potential financial transaction from a list.

Additionally or alternatively, the potential financial transaction is an online transaction that is identified according to a web address, such as a browsed uniform resource locator (URL) and/or the like.

Additionally or alternatively, the potential financial transaction is a transaction that is performed using an application installed on and/or executed by the consumer terminal 108, for example a digital wallet (also known as an e-wallet) application that allows the consumer to make electronic commerce financial transactions. The financial transactions may be identified and extracted by the application. The method 200 may be implemented during a purchase session of the application, providing the consumer with a number of optional transaction terms offers to select from.

Additionally or alternatively, the potential financial transaction is a transaction that is advertised to the user, for example by an electronic message, a banner, and/or a short message service (SMS) and identified according to a relation to parameters of the advertisement. Additionally or alternatively, a potential financial transaction is identified by a consumer module installed on a handheld device that includes a navigation module and optionally a camera, for example a Smartphone. The navigation module acquires current positional data of the consumer and the camera images a barcode or any other machine-readable code or symbol indicative of a product. A message which includes a combination of current positional data and product indication is optionally sent to the central unit 101, optionally together with a consumer identifier. The central unit 101 matches the current positional data with current positional data of one or more retailers. Based on the identified retailers and the product indication one or more potential financial transaction(s) are identified, for example using database(s) documenting products sold by retailers.

Now, as shown at 202, payment methods available for performing the potential financial transaction are identified, for instance a financing provider. As used herein, a method of payment may be a credit card type, a credit card consumers club, a membership in a consumers club, a coupon, a Web-based financing service, such as PayPal™ account, a cash payment, virtual credit card and/or the like.

The payment methods optionally include payment methods which are associated with the consumer, for example credit card services, coupon services and/or consumer clubs to which the consumer is registered. The payment methods maybe extracted from a consumer record stored on the consumer terminal 108 and/or in the database 104, for example as one of a plurality of consumer records which may be stored in an internal database of the central unit 101, or in an external database 114. The consumer record may include consumer identifier, demographic data, logged financial transactions history, and/or the like. The payment methods optionally include new payment methods which are made available to the consumer, for example suggested thereto based on her profile, payment methods available thereto, and/or the potential financial transaction, for example virtual credit card services, new coupon services and/or new consumer clubs, either currently existing and/or virtually adapted and automatically created for one or more consumers. For brevity, payment methods which are available or made available to the consumer are referred to herein as payment methods which are available to the consumer. Optionally, the new payment methods are identified using an advertisement module 115 that is installed on the central unit 101. The advertisement module 115 may match the consumer profile with respective payment method profiles.

According to some embodiments, the retailer module 109 allows a retailer to set a bid for payment transactions and to select payment transactions which are beneficial for it, for example require minimal commission, payment terms, for example delayed payment period, insurance costs, risk management policies and/or the like and/or having terms which are preferable for its consumers.

Optionally, the retailer module 109 and/or a module installed in the register device of the retailer (and/or any other payment device) are set to file a bid when a consumer requests to perform a specific transaction. For example, when a consumer requests to purchase a product, the respective module identifies a list of the payment methods which are available thereto, for example as described herein, optionally including virtual financing service providers. The module addressees each financing service provider to acquire payment terms for the specific transaction. Each one of the financing service providers performs an analysis and calculates accordingly payment terms. The payment terms may be calculated based on a single transaction and/or all the transactions of the certain retailer. The payment terms are sent back to the module which prioritize the received payment terms according to one or more rules, for example commission, preferences, benefits for the consumers and/or the like. Optionally different criterions are weighted differently. The module optionally adjusts the consumer's payment, for example reduces the payment if the commission is below a certain threshold and/or increases the payment if the commission is above another threshold.
The module may output optional routes for the consumers, allowing him to select one out of a number of payment options. Optionally, payment options are adjusted so as to provide a consumer with incentives to select one payment option over another. Optionally, the module allows a retailer to provide rules and/or weights according to which payment terms are prioritized.

According to some embodiments, the matching module 107 of the system 100 or another module, referred to herein combination module, is set to match a plurality of financing provider—consumer—retailer combinations and to select and/or to prioritize accordingly one or more combinations. The combination module optionally checks combinations that define a number of consumers, a number of retailers, and/or a number of financing providers.

In these embodiments, when a transaction is detected, for example as described above, payments terms are acquired for the transaction and optionally for a combination of the transaction with other transactions, for example a set of transactions gathered during a certain period and/or estimated to be performed in a certain period. The module optionally addresses virtual financing service providers. The address optionally includes some or all of the transaction details, for example as described herein. Optionally, the transaction is split to sub transactions which are sent to the providers, facilitating combining a number of offers from different financing service providers, optionally including virtual financing service provider(s). Optionally, financing service providers are addressed gradually, allowing one financing service provider to finance a transaction declined by another financing service provider.
In addition, the optional clearing terms for the retailer, per transaction are identified, from a plurality of different financing service providers.
Now, combination(s) are selected and/or prioritized based on the gathered data. Optionally, the clearing terms and the payment terms are weighted. Optionally, all optional combinations are scored according the priority of the clearing terms and the priority of payment terms. The selected and/or one or more top prioritized combination(s) are automatically recommended to the retailer and/or the consumer. Alternatively, a selected and/or a prioritized combination is automatically used for charging the consumer.

Optionally, one or more of the financing providers are virtual financing service providers that debit the client via another financing provider, via her bank account, another payment method and/or the like. In such an embodiment, the payment method includes using a temporary payment card details (e.g. number, expiration date) that is provided to the consumer (or to the unit that performs the transaction automatically) for the potential financial transaction(s). The virtual credit card service provider may be used as a payment method for members of a certain group that is defined by the system 100 or provided as new payment method to selected consumers. The virtual credit card provider defines certain profile(s) of consumers he is interested to grant them this special service on preferred terms for a single or multiple transactions (e.g. grating special 10% discount, 3 installments with no interest for consumers that sending a request for terms on transaction in gas stations and from their history they are paying at least $500 per month for gas and currently are not carrying my card).

As outlined above, the system 100 enables a financing provider to issue one or more virtual payment identifiers consumers. A virtual payment identifier, for example a virtual credit card number (optionally including related data, such as CVV and issue date), is issued by one or more financing providers. The virtual payment identifier is dynamically allocated to the consumer per transaction, for example based on transaction data, such as location, retailer, product, sum, date, and/or the like. The virtual payment identifier, for example a virtual credit card number, is issued according to demographic characteristics of the consumer and/or debiting venue. The virtual payment identifier may be forwarded to be presented to the retailer and/or the consumer and/or automatically feed during a transaction.

Optionally, the virtual payment identifier is approved by the virtual payment service provider. Optionally, a virtual payment identifier is given to a certain sum which is larger than the sum of a current transaction, requiring from the consumer to perform a number of transactions using the virtual payment identifier. The virtual payment identifier may be identified based on currency, for example providing a low currency exchange rate.

Now, optionally as shown at 203, transaction terms offers for performing the potential financial transaction using any of the identified payment methods are acquired, for example calculated or selected, optionally automatically. The transaction terms offers may be general transaction terms which apply to all consumers who have a certain payment method available, for example member in a certain consumer club and/or use a certain credit card, identified as suitable for a new payment method, personalized transaction terms which are selected for the consumer, for example as described below, and/or ‘ad hoc’ transaction terms which are adjusted online, in real time, based on changes in variables such as interest rate, inventory, agreements between the retailer and the financing provider and/or the like.

Optionally, transaction terms offers for performing the potential financial transaction using any combination of the identified payment methods are acquired, for example calculated or selected, optionally automatically. In such an embodiment, the potential financial transaction is divided, for example by the matching module 101 or the user using a designated UI, to a plurality of sub transactions. In addition, a plurality of combinations each of a group of the payment methods which are available to the consumer are selected. Then, a transaction term offer for performing the potential financial transaction using any of the combinations is calculated wherein each member of the group is assigned with another sub transaction. The calculated transaction term offer is then output for presentation to the consumer.

Optionally, a request for transaction terms offer, also referred to herein as a bid, is sent to one or more financial services provider(s), for example to the financing provider modules 111. For example, a financial services provider is identified for each identified payment method, for example using an index or a hash table. Additionally or alternatively, the bid is sent to the retailer, for example to the retailer module 109. Benefits optimization with same mechanism as financing provider on a standalone basis (no need for collaboration with financing provider. In such a manner, the retailer may adjust the transaction terms offer based on information it has pertaining to the consumer and/or relationship with the financing provider. The bid is indicative of the potential financial transaction (e.g. purchase amount, interest on required installments) and optionally the consumer. The bid optionally provides consumer identifier, consumer information, for example purchase history, credit status, statistical information and/or the like. Each one of some or all of the recipients, for example financing provider modules 111, calculates transaction terms and reply to the bid with the transaction terms offer. In such a manner, a financing provider can put offers to various bids which are submitted by various consumers.

The offers may be set dynamically according to changes in the interest rate, changes in the profile of the consumer or respective retailer and/or the like. The offers may be set dynamically according to information the financing provider has about the respective consumer or information provided by the central unit, for example the global consumer's profile derived from her purchase history on all payment methods. Optionally, the offers includes time dependent terms, such as a discount which is given at a certain time, history dependent terms, for example a discount based on the last transaction(s), a discount for a repeat transaction within a certain period, a discount based on a current payment cycle activity and/or the like. Optionally, the offers may be personalized, for example by name, preference, history of which offers were accepted by the consumer and/or the like. Optionally, offers to bids are provided in real time to potential financial transactions which are about to be executed by consumers of the system 100. In such an embodiment, the central unit 101 functions as a proxy that connects between various financing providers and the consumer. The consumer can receive a plurality of transaction terms offers for a potential financial transaction she is about to make based on dynamic variables which change in real time.

Benefits can be grated to a group of consumers by accumulating their activities as a group rather than one consumer at a time. On this model the consumers registered as members of a certain group, for example group of socially connected friends in a social network, and ask to get from a financial provider, a retailer or a group or retailers the benefits as a group. For example, 20% discount may be provided to a group of consumers when the sum of purchases from one or more specified retailers reaches a certain amount, for example $1000, within a period, for example 10 days, optionally, a consumer may define recruit friends to a certain group. The members of the group receive notices on an updated joint balance and the required terms to meet (e.g. the group has reached a balance of $897, purchases of $103 are still required to be carried for reaching the 25% discount to the group).

Optionally, the potential financial transactions, which are identified for a certain consumer, and optionally their outcome (i.e. financial transaction have occurred or not) are documented, for example logged in a respective consumer record. In such a manner, the system 100 may gather information about financial transactions performed by the user using a number of different payment methods, for example a number of different credit services, cash, coupons and/or the like. Optionally, the documented potential financial transactions are used for the calculation of transaction terms. For example, if a consumer frequently purchases a certain product or service, the retailer and/or the financing provider may like to compensate him, for example with a discount or a related benefit. Optionally, the outcome of documented potential financial transactions may be analyzed to estimate statistically the efficacy of offers with certain transaction terms.

Optionally, the system 100 includes a transaction aggregator that acquires offers for automatically formed groups of consumers. In use, the transaction aggregator identifies a plurality of consumers which are about to perform potential financial transactions with a common retailer or a group of retailers having a common interest in real time. For example, the transaction aggregator identifies all the potential financial transactions which are about to occur in a gas station of a certain gas station chain. Then, the transaction aggregator negotiates the prices for this group based on the size of the group and/or the scope of the purchase, for example with the respective financing provider module. This allows the transaction aggregator to generate an offer and to add it to the other offers which are provided to the respective consumers.

According to some embodiments, a predicted transaction cost is calculated for each transaction terms offer, for example by taking into account transaction terms, such as discount, interests, potential penalties and/or the like. Optionally, the predicted transaction cost takes into account penalties and/or discounts that apply on the consumer due to exceeding or complying with a credit line and/or the like. This information may be kept updated in the respective consumer records. The calculation may be of a probability the consumer will exceed the credit line and based on an analysis recorded financial transactions. The calculation may be performed on the consumer terminal 108 and/or in advance, for example at the matching module 107.

Optionally, a predicted transaction cost is calculated for paying by one or more combinations of payment methods. In such an embodiment, the consumer may maximize the benefit from the purchase by paying using a number of payment methods. For example, the predicted transaction cost of a combined payment wherein one half is paid with a first card and the other is paid with a second card.

Optionally, the system predicts future transactions to be taken by a consumer using a plurality of payment methods in order to predict the actual cost of each transaction. Based on this predicted future transactions, the expected balance on each respective account is assessed and used to calculate when to expect credit line exceeding and the expected penalties the customer will be charged for.

According to some embodiments, the system 100 ranks each one of the identified transaction terms offers. Optionally, the transaction terms offers are ranked according to a profitability analysis of the respective transaction terms and/or his bank account/s credit status (e.g. when a user has more than one bank account and credit cards are split between these accounts) and/or instructions from the advertisement module 115, for example based on payment method grade(s). Additionally or alternatively, one of the payment methods is selected automatically and used for executing the potential financial transaction. The selection is optionally based on a profitability analysis of the transaction terms.

Optionally, the matching module 101 analyzes the transaction terms offers of different payment methods and optionally expected transactions and obligations of each payment methods, for example each credit card, and selects the best payment method and terms.

In an exemplary case, the matching module 101 analyzes the transaction terms offers and selects one or more of them for the execution of the potential financial transaction based one or more of the following:

a combined purchase cost analysis that takes into account the usage/installments fees, interests, and penalties, for example a purchase of $23 with all expenses is expected to cost $34;

an account expenses analysis that takes into account predicted payments, their probability to actually occur, and/or how they affect the account fees on the long run;

new granted benefits analysis that takes into account new benefits granted to the consumer and optionally the value thereof for future payments e.g. payment with card A will grant benefits that could be used for a $14 discount on customer's purchases on eBay; and

benefits redemption analysis that determines if it more effective to redeem the existing benefits (cashback usage, discount points and/or the like) or to save it for future transactions (i.e. cashback will grant a discount of $5 on this current purchase while on the future airline ticket it worth $30 and there is a chance of 65% the consumer will buy this ticket).

Optionally, the transaction terms offers are ranked and/or selected based on a calculation of combined purchase costs. The calculation of the combined purchase cost takes into account the usage/installments fees, interests, penalties, account expenses, and/or predicted payments, optionally weighted according to their probability to occur. Optionally, the transaction terms offers are ranked according to preferences of the consumer. For example, the consumer may weight and/or otherwise mark the importance of difference transaction terms thereto. For example, the number of installment may be marked as important and general benefits may be marked as less important. In such an embodiment, compatibility with the preferences of the consumer may lead to a higher ranking.

Optionally, the transaction terms offers are ranked according to a contribution to a credit plan, obligation(s) of the consumer and/or accounts' predicated balances as described above. For example, if a user is obliged to perform a certain number of transactions with a certain payment method and/or to exceed a certain expense, the respective payment method is ranked higher, optionally in graded manner so that when the due date is closer the rank is higher. For example, if card A is ranked as the best for groceries purchases and therefore about to reach a credit ceiling before the end of the month, the penalty for breaking the credit line is taken into consideration and the ranking thereof decreases.

Optionally, the ranking of the transaction terms offers may be updated dynamically, for example according to changes which are set by the financing providers, retailers, consumer preferences updates and/or benefits which are collected from performed financial transactions. For example, when benefits are granted for a transaction the ranking of a transaction offer wherein the benefits may be used is increased.

The transaction terms offers of the identified transaction terms offers are outputted, for example forwarded to the client terminal 108 of the consumer, optionally for presentation, as shown at 204. In such a manner, the consumer can select a payment method based on a comparative analysis of the transaction terms offers which are available thereto. Optionally, the transaction terms offers are sent in a message from the central unit 101 to the consumer module 107. The message includes a list of all relevant transaction terms offers, the actual purchase cost of using each respective payment method, and optionally a score of each transaction terms offer and/or a suggested payment method to use. Optionally, each member of the list includes transaction terms, for example the number of optional installments, regular payment cost, rewards redemption and/or the like. Optionally, the aforementioned ranking is used for arranging the order of the optional potential financial transactions.

Optionally, data pertaining to the transaction terms offer which is selected by the consumer is forwarded to one or more of the retailer modules 109 and/or the financing provider modules 111, for example from the respective consumer module and/or the cash register. In such a manner, retailers and/or financing providers receive data indicative of which transaction terms offers are accepted and which failed to concise the consumer. Optionally, the accepted transaction terms offer is indicated manually, for example by the consumer who marks the selected transaction terms offer on a designated user interface. Optionally, the accepted transaction terms offer is indicated automatically, for example by a paying application, for example a digital wallet application, which is used for taking the selected transaction terms offer. Optionally, the accepted transaction terms offer is indicated automatically, for example by a message sent to the consumer modules 107, the retailer modules 109 and/or the financing provider modules 111. The message may be sent by the cash register and/or the financing provider which offered the financing provider.

According to some embodiments, the system 100 is set to encourage group purchases and the purchases are potentially taken by a group of consumers that were bind as a group. In such an embodiment, a transaction terms offer may be conditional, for example depends on a number of purchasers, a daily volume of financial transactions of a certain potential financial transaction and/or the like. For example, the condition may be an additional discount when the number of purchasers that uses the respective payment method (taken by any customer from the group) exceeds a predefined amount, for instance additional 10% discount when the number of purchasers which uses MasterCard™ credit in the store in a certain day is 200 or more. Optionally, the central unit 101 includes a documenting module which documents the potential financial transactions, for example as described above. This allows monitoring whether the conditional terms of the transaction terms offer take place or not.

According to some embodiments, the system 100 provides a consumer with a search tool that allows searching for potential financial transactions to perform. In such an embodiment, the user may compare transaction terms offer she receives for a searched product or service. For example, if a user has doubts from which retailer to purchase a product, he may acquire transaction terms offers for potential financial transactions of same product, each with another retailer. The comparison may be performed automatically, for example by adding respective transaction terms offers to a respective presentation on the consumer terminal 108. The comparison may be performed automatically, for example in response to a user request.

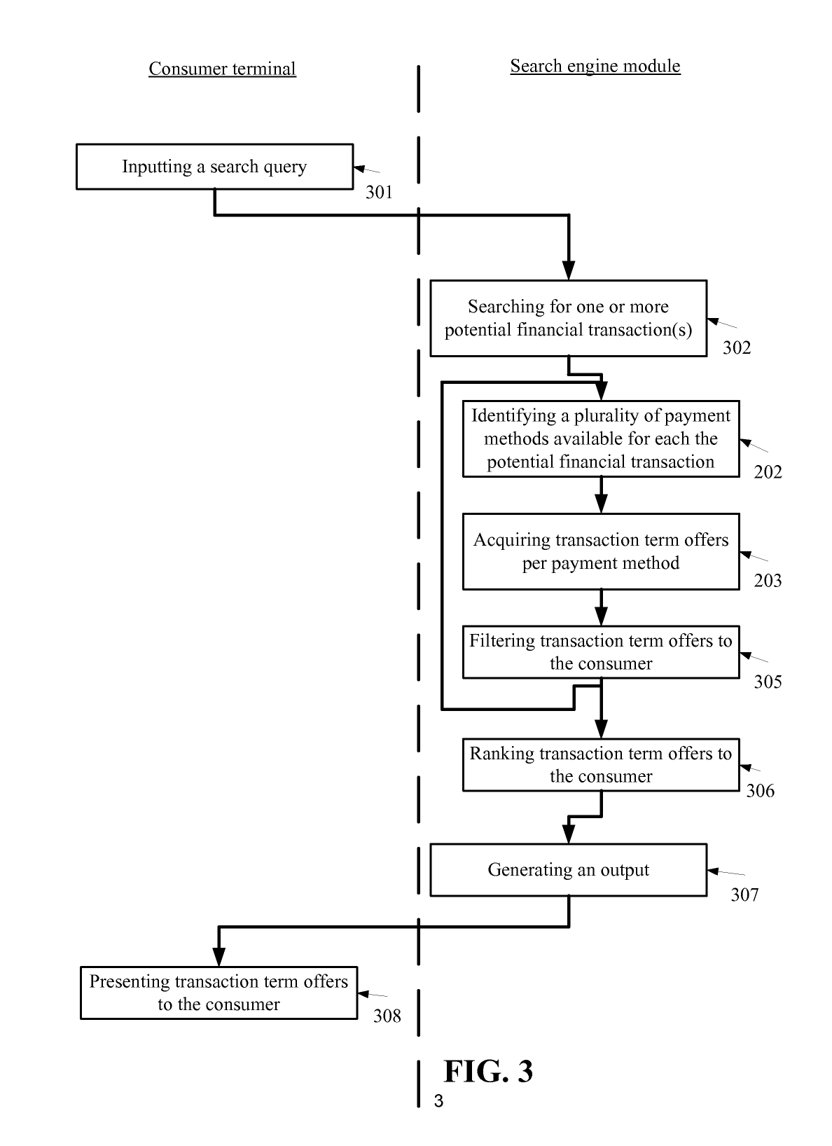

For example, reference is now also made to FIG. 3, which is a flowchart of a method 300 of searching transaction terms offers for one or more potential financial transactions based on a query defining one or more products and/or services, according to some embodiments.

First, as shown at 301, a search query is inputted by the user. Optionally a search graphical user interface (GUI) is presented to the consumer, for example either as an add-on or an application that is installed on the consumer terminal 108, for example an extension of the consumer module 107, or as a widget or another interface on a webpage. Optionally, the search query defines a searched product and one or more transaction terms. Optionally, the search query includes locational boundaries, for example a radius around the current location of the consumer terminal 108. Now, the search query is forwarded to search engine module 116 that is optionally hosted on the central unit 101. The search engine module 116, as shown at 302, searches for one or more potential financial transactions 302 that meet at least some of the search query criteria. These potential financial transactions may be searched for in the database(s) 104, 114 and/or in databases of third parties, for example in an updatable index that is created and/or updated by web crawlers.

Per identified potential financial transaction, as shown at 202 and described above, a plurality of payment methods, which are available for the consumer, are identified. For each payment method, as shown at 203 and described above, a transaction term offer is acquired. During the acquisition of transaction term offers the search query may be used as consumer preferences, for example for allowing the financing provider and/or the retailer to meet the consumer's terms.

As shown at 305, some or all of the transaction term offers of each identified potential financial transaction may be filtered according to transactions documented in the search query. For example, of the search query defines a number of installments, the transaction term offers which do not offer at least the searched number of installments are filtered.

As shown at 306, per identified potential financial transaction, the transaction term offers which are not filtered are ranked, for example as described above. Optionally, transaction term offers which receive a rank below a predefined threshold are removed. Now, as shown at 307, the central unit 101 generates an output which is then forwarded for presentation at consumer terminal, as shown at 308. For each identified potential financial transaction, transaction term offers may be ordered according to the rank and/or other characteristics, optionally user selected. Optionally, identified potential financial transactions are ordered according to the rank(s) of the respective transaction term offers. For example, a potential financial transaction with a highly ranked transaction term offer is placed above a similar potential financial transaction with a transaction term offer which received a lower rank. In such an embodiment, transaction term offers for the potential financial transactions are sent as a response to a search query defining a requested product and/or service and optionally a location and/or one or more transaction terms.

In such embodiments, a consumer may send a search query that asks for potential financial transactions pertaining to purchasing gas in proximate gas stations. By analyzing the location of the consumer and the financial transactions records, prices and special discounts for gas that offered by proximate gas stations are collected. Based on the prices on each gas station and the offered transaction terms combinations from the payment methods, each combination of a place and a payment method which is available to the consumer may be ranked and presented to the consumer. Additionally or alternatively, one or more combinations may be selected automatically for the consumer. Optionally, the transaction terms offers of certain payment methods and/or transaction terms offers of combinations payment methods are ranked and/or selected based estimated transaction data, for example estimated benefit from future transactions, estimated future transactions, estimated future balances, and/or the like.

According to some embodiments, the system 100 presents a consumer with a one or more transaction terms offers from each one of a plurality of potential financial transactions which are identified as suitable thereto, for example upon request and/or by using push messages. The suitability may be identified using the aforementioned search methodology. In such an embodiment, the search query may define terms which are preferred to the consumer and the product and/or service may be extracted from based on personalized advertisement unit, for example as known in the art. For example, the search query may be based on the location of the consumer, changes in a dynamic user profile and/or the like. The response may include a plurality of optional potential financial transactions, each associated with one or more transaction terms offers which are optionally selected according to the payment methods which are available to the consumer.

It should be noted that as the system 100 allows financing providers to provide transaction terms offers to bids it actually increases the exposure of consumers to the services the financing providers and retailers offer and in such a manner may increase their revenues. According to some embodiments, the system 100 comprises a billing module 117 that manages the debiting of financing providers based on the transaction terms offers which are distributed using the system, for example by monitoring the potential financial transactions which are forwarded to the central unit 101, the transaction terms offers which are forwarded to consumers and/or the transaction terms offers are accepted by the consumer(s). For example, the billing module 117 calculates a commission on one or more of the following: a volume of transaction terms offers which are accepted by consumers;

a commission on the volume of financial transactions that wouldn't have been carried without the system 100, for example based on behavior patterns analysis assessing the system 100 contribution for this transaction; revenues generated by financial transactions carried out using the system 100;

a probability of a customer not to use the financing provider service for a given transaction if the financing provider did not have the opportunity to use the system 100 (e.g. a customer is carrying a transaction of $78 where transactions with same profile were carried 10 times on the last year while only 1 of them was carried by the respective financing provider service—the commission is calculated as follows: (10− 1/10)%*$78*commission rate); and

an average volume that was added to the financing provider when using the system 100 in relation to the volume of a previously recorded volume without using the system 100.

Optionally, the billing module 117 bills the financing provider for accessing records, for example consumer profiles and/or transaction terms offers history and/or user requests and/or users benefits preferences. Optionally, the billing module 117 bills the financing provider for adjusting the ranking of its ranking, for example as described above and/or for the presentation of its offers in response to a search query and/or an identified potential financial transaction. Optionally, the billing module 117 bills the financing provider receiving bids. Optionally, the billing module 117 bills joining consumers. Optionally, the billing module 117 bills retailers for services. Optionally, the billing module 117 bills the consumers for accessing premium content. It should be noted that the ability to provide automatically and dynamically transaction terms offers to consumers allow financing providers to promote their services to new client and to compensate existing client for their loyalty. For example, loyal consumers will enjoy more flexible transaction terms offers and benefits.

Optionally, each one of the financing provider modules manages a real-time and dynamic decision process to determine effective transaction term offers which are granted to a given potential financial transaction or a sequence of potential financial transactions. The transaction term offers are given to transactions carried by registered or non-registered consumers. On this process, the financing provider module 107 calculates the value of potential financial transaction(s) which are about to occur for a respective financing provider. The value of consumer on the long run and costs of benefits and/or terms may be taken into account. For example, the dynamic decision process calculates one or more of the following: information pertaining to a financial transaction (i.e. type of merchant, an amount, a location, a preferred terms);

consumer account information, such as current balance, past transactions, future transactions, current account terms, customer commercial class level, customer risk level, processors fees card expiration date and/or the like; and

global customer profile which optionally takes into account the entire customer's history of transactions and related requests for offers.

A decision process takes into account optional terms that can be granted to the consumer and performs an analysis for assessing the preferred terms' costs, with these terms the probability and cost of losing the transaction, the probability and cost of losing the customer and/or the probability to increase customer's purchasing volume with the card and the expected revenues that will be generated.

Based on this process the different terms are ranked and used for deciding on the most cost effective terms to offer on this given transaction (i.e. a customer with high profile air-line tickets purchasing history of $10,000 per year. The financing provider assessing whether to grant a special discount of $30 for the next transaction he asks to carry along with the assessed 60% potential to draw the customer to issue a card and to generate annual revenues of $200 on the next years).

It is expected that during the life of a patent maturing from this application many relevant systems and methods will be developed and the scope of the term a computing unit, a server, a processor, a network and a terminal is intended to include all such new technologies a priori.

As used herein the term “about” refers to ±10%.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment may include a plurality of “optional” features unless such features conflict.

Throughout this application, the various embodiments may be presented in a range format. It should be understood that the description in range format is merely for convenience and brevity and should not be construed as an inflexible limitation on the scope of the disclosed embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features, which are, for clarity, described in the context of separate embodiments, may also be provided in combination in a single embodiment. Conversely, various features, which are, for brevity, described in the context of a single embodiment, may also be provided separately or in any suitable sub-combination or as suitable in any other described embodiment. Certain features described in the context of various embodiments are not to be considered essential features of those embodiments, unless the embodiment is inoperative without those elements.

Although the various embodiments have been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of providing a consumer with different transaction terms offers for performing a potential financial transaction, comprising:
identifying a potential financial transaction between a retailer and a consumer;
identifying a plurality of payment methods which are available to said consumer for performing said potential financial transaction;
acquiring a plurality of transaction terms offers for performing said potential financial transaction each using another of said plurality of payment methods; and
outputting respective said plurality of transaction terms offers for presentation to said consumer.

2. The method of claim 1, wherein identifying said potential financial transaction further comprises: identifying a location of said consumer and matching said location with a plurality of records each indicative of one of a plurality of potential financial transactions in one of a plurality of locations.

3. The method of claim 1, wherein said identifying said potential financial transaction further comprises: identifying a web address and matching said web address with a plurality of records each indicative of one of a plurality of potential financial transactions in one of a plurality of web addresses.

4. The method of claim 1, wherein each said payment method is acquired from a terminal of a financing provider that provides a service, wherein said service is at least one of: a credit card type, a consumers club, a coupon service, a Web-based financing service, and a cash payment.

5. The method of claim 1, wherein acquiring said plurality of transaction terms offers further comprises:
identifying at least one characteristic of said consumer by analyzing at least one of a history of financial transactions, at least one demographic characteristic, and available payment methods, and
forwarding said at least one characteristic to plurality of terminals which provide said plurality of transaction term offers accordingly.

6. The method of claim 1, wherein acquiring said plurality of transaction terms offers further comprises:
identifying an additional payment method which is currently not available to said consumer,
sending information pertaining to said consumer to a provider module associated with said additional payment method, and
acquiring at least one additional transaction term offer in response to said information; wherein said outputting comprises outputting said at least one additional transaction term offer.

7. The method of claim 6, wherein said at least one additional transaction term offer includes a temporary credit card number for performing said potential financial transaction.

8. The method of claim 1, wherein acquiring said plurality of transaction terms offers further comprises: adjusting at least one of said plurality of transaction terms offers according to a change in a member of a group consisting of an interest rate, a demand for said potential financial transaction, a profile of said consumer, and history of previously conducted financial transactions.

9. The method of claim 1, wherein acquiring said plurality of transaction terms offers further comprises extracting a consumer profile record of said consumer and personalizing at least some of said plurality of transaction terms offers according to said consumer profile record.

10. The method of claim 1, wherein outputting respective said plurality of transaction terms offers comprises: calculating a predicted transaction cost of each said transaction terms offer and ranking each said transaction terms offer according to said predicted transaction cost.

11. The method of claim 1, wherein each said plurality of transaction terms offer defines at least one member of a group consisting of a number of optional installments, a regular payment cost, rewards redemption, and at least one benefit to said consumer.

12. The method of claim 1, wherein acquiring said plurality of transaction terms offers further comprises:
dividing said potential financial transaction to a plurality of transactions,
defining a plurality of combinations each of a group of said plurality of payment methods, and
acquiring a plurality of additional transaction term offers for performing said potential financial transaction each using another of said plurality of combinations;
wherein said outputting comprises outputting said plurality of additional transaction term offers for presentation to said consumer.

13. The method of claim 1, wherein acquiring said plurality of transaction terms offers further comprises: ranking each one of said plurality of transaction term offers; wherein said outputting comprises acquiring one of said plurality of transaction term offers for automatically performing said potential financial transaction according to said ranking.

14. The method of claim 13, wherein ranking each one of said plurality of transaction term offers is performed according to a credit line of said consumer in each said payment method.

15. A non-transitory computer readable medium comprising computer executable instructions configured to perform the method of claim 1.

16. A system of providing a consumer with different transaction terms offers for performing a potential financial transaction, comprising:
an interface configured to receive from a consumer terminal via a network an indication of a potential financial transaction between a retailer and a first of a plurality of consumers; and
a matching module configured to select one of a plurality of consumer records according to said indication and acquires a plurality of transaction terms offers for performing said potential financial transaction using any of a plurality of payment methods which are available to said first consumer a via said network;
wherein said interface is configured to forward said plurality of transaction terms offers to said consumer terminal so as to allow the presentation thereof to said first consumer.

17. The system of claim 16, further comprises:
a billing module configured to monitor an outcome of presenting said plurality of transaction terms offers to said consumer and updates a billing record of one of the operators of said plurality of financing provider terminals accordingly.

18. The system of claim 16, further comprises a database configured to store a plurality of consumer records each documenting a plurality of payment methods which are available for another of a plurality of consumers.

19. The system of claim 16, wherein said matching module is configured to acquire respective said plurality of payment methods which are available to said first consumer from said database.
